(19) United States
(12) Patent Application Publication
(10) Pub. No.: US 2007/0195027 A1
(43) Pub. Date: Aug. 23, 2007

(54) Method of displaying moving image on a liquid crystal display panel

(76) Inventors: Hsu-Chang Yang, Tao-Yuan Hsien (TW); Shuo-Feng Chang, Tao-Yuan Hsien (TW); Shui-Lien Chen, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/379,573

(22) Filed: Apr. 21, 2006

(30) Foreign Application Priority Data
Feb. 22, 2006 (TW) 095105964

(51) Int. Cl. G09G 3/36

(52) U.S. Cl. 345/87

(57) ABSTRACT

A display method capable of displaying motion images includes displaying a first image, displaying a white or a gray image after displaying the first image, and displaying a second image subsequent to the first image after displaying the white image or the gray image using a liquid display panel. The method improves the display quality of moving images and the visual brightness of the liquid display panel by inserting white or gray images in order to reduce the frame delay of the liquid display panel.

### BACKGROUND OF THE INVENTION

1. Field of the Invention

The present invention is a method of displaying for a liquid crystal display, and in particular, a method of displaying moving images on a liquid crystal panel.

2. Description of the Prior Art

Due to the fact that liquid crystal display devices are thin, light, use little power and output little radiation, they are used in various portable applications such as personal digital assistants (PDAs), digital cameras and camcorders, and are replacing conventional cathode ray tube (CRT) displays. However, the liquid crystal display device has its downside. When switching images, it is required to twist the orientation of liquid crystal molecules because of the limitations of liquid crystal molecules. Thus there is a delay in image display, and this is particularly obvious when the image being displayed is a moving image.

The most effective way to eliminate the delay effect in image displaying on liquid crystal display devices is to increase the response time of liquid crystal materials. However, the liquid crystal material has a limitation of its response time; therefore, in general cases, the black image insertion technique is used. The technique inserts a black image in between each frame period, producing a fast pulse modulation effect similar to what the CRT does. Human brains filter such flickers and automatically generate a medium image, hence minimizing the effect of image delay.

Please refer to FIG. 1. FIG. 1 explains a method of the prior art, which solves the image delay phenomenon of a liquid crystal display device by inserting black images. In the figure, images P₁ to Pₙ represent the images displayed at time T₁ to Tₙ respectively on a liquid crystal display panel of a liquid crystal display device. Images B₁ to Bₙ are black images, while the time period between the two sequential times of T₁ to Tₙ defines frame periods F₁ to Fₙ. In order to minimize the image delay phenomenon, the solution provided by the prior art is to insert a black image between a normal display image of a frame period and a normal display image of the next frame period. The first step is to divide each of the frame periods F₁ to Fₙ into two sub-frame periods F₁ₐ to Fₙₐ and F_{1b} to F_{nb}, where the sub-frame periods F₁ₐ to Fₙₐ start at times T₁ to Tₙ and the sub-frame periods F_{1b} to F_{nb} start at times T₁′ to Tₙ′ respectively. Then, normal display images P₁ to Pₙ between sub-frame periods F₁ₐ to Fₙₐ of frame periods F₁ to Fₙ, are displayed and black images B₁ to Bₙ between sub-frame periods F_{1b} to F_{nb} of frame periods F₁ to Fₙ are displayed.

The method of the prior art represented by FIG. 1 is able to minimize the image delay phenomenon; nevertheless it reduces the quality of the visual performance of luminance of the liquid crystal display panel. This is because every frame period is required to be divided into sub-frame periods and one of the sub-frame periods is used to display the black image.

### SUMMARY OF THE INVENTION

The present invention provides a method of displaying a moving image on a liquid crystal display panel comprising the liquid crystal display panel displaying a first image; then the liquid crystal display panel displaying a white image or a gray image after displaying the first image; the liquid crystal display panel displaying a second image subsequent to the first image after displaying the white image or the gray image.

The present invention also provides a method of displaying moving images comprising providing a moving image formed by a plurality of sequential frames, any two sequential frames of the plurality of sequential frames being separated by a first fixed time interval; and providing a plurality of white images or gray images alternating with the plurality of sequential frames, any two sequential white or gray images of the plurality of white images or gray images being separated by a second fixed time interval.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 explains a method of the prior art is to minimize the image delay phenomenon by inserting black images.

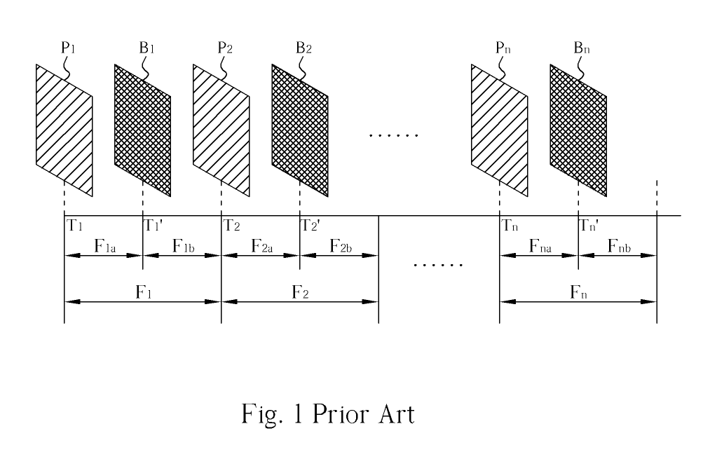

FIG. 2 explains a first embodiment of the present invention is to minimize the image delay phenomenon by inserting white images.

FIG. 3 is a block diagram of a liquid crystal display device of the present invention.

FIG. 4 is a diagram of the liquid crystal panel displaying normal images.

FIG. 5 is a diagram of the liquid crystal panel displaying white images.

FIG. 6 explains a second embodiment of the present invention is to minimize the image delay phenomenon by inserting white images.

FIG. 7 explains a third embodiment of the present invention is to minimize the image delay phenomenon by inserting white images.

FIG. 8 explains a fourth embodiment of the present invention is to minimize the image delay phenomenon by inserting gray images.

FIG. 9 explains a fifth embodiment of the present invention is to minimize the image delay phenomenon by inserting gray images.

FIG. 10 explains a sixth embodiment of the present invention is to minimize the image delay phenomenon by inserting gray images.

### DETAILED DESCRIPTION

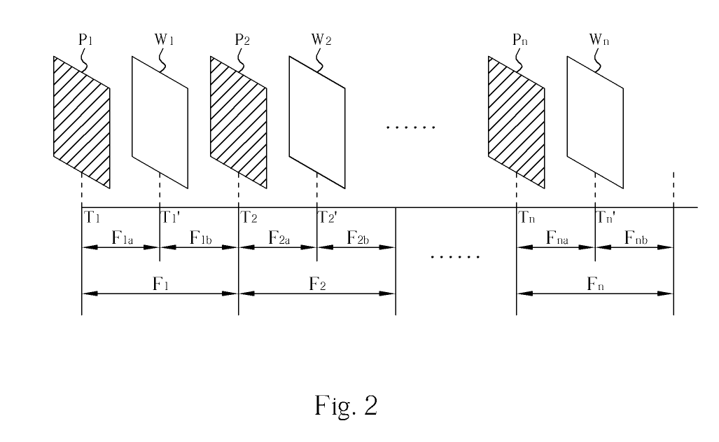

Please refer to FIG. 2, which explains a first embodiment of the present invention, which is to solve the image delay phenomenon on liquid crystal display devices using a white image insertion technique. In FIG. 2, images P₁ to Pₙ represents the images displayed by a liquid crystal display device at time T₁ to Tₙ; images W₁ to Wₙ are white images; and time intervals between each of the two sequential times T₁ to Tₙ are defined as frame periods F₁ to Fₙ. In order to minimize the image delay phenomenon, the solution provided by the first practice is to insert a white image between a normal display image of a frame period and a normal display image of the next frame period. The first step is to divide each of the frame periods F₁ to Fₙ into two sub-frame periods F₁ₐ to Fₙₐ and F_{1b} to F_{nb}, where the sub-frame periods F₁ₐ to Fₙₐ start at times T₁ to Tₙ and the sub-frame periods F_{1b} to F_{nb} start at times T₁′ to Tₙ′ respectively. Then the liquid crystal display panel displays normal display images P₁ to Pₙ between sub-frame periods F₁ₐ to Fₙₐ of frame periods F₁ to Fₙ, and displays white images W₁ to Wₙ between sub-frame periods F_{1b} to F_{nb} of frame periods F₁ to Fₙ. The inserted white images W₁ to Wₙ not only minimize the image delay phenomenon but retain the quality of vision performance of the luminance of the liquid crystal display panel.

In the first embodiment of the present invention, images P₁ to Pₙ can be sequential images of a moving image. The time intervals between each of the two sequential images P₁ to Pₙ can be equal to or longer than the time intervals between each of the two sequential white images W₁ to Wₙ, for example: F₁≧(F_{1b}+F₂ₐ).

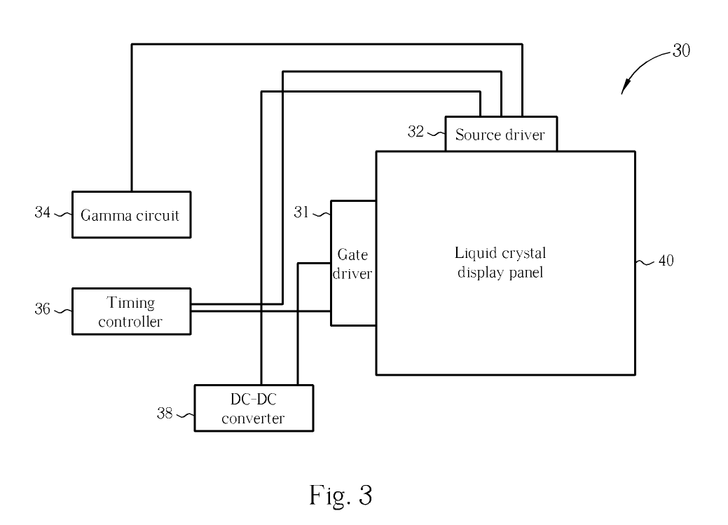

Please refer to FIG. 3. FIG. 3 is a block diagram of a liquid crystal display device 30 of the present invention. The liquid crystal display device comprises a liquid crystal display panel 40, a gate driver 31, a source driver 32, a gamma circuit 34, a timing controller 36 and a DC-DC converter 38. The operation of the liquid crystal display device 30 is well known by people in the field, therefore description regarding it is not going to be repeated here. The present invention using the white image insertion method to minimize the image delay phenomenon includes using the timing controller 36 to control data output of each frame period to display normal display images P₁ to Pₙ between sub-frame periods F₁ₐ to Fₙₐ of frame periods F₁ to Fₙ, and displaying white images W₁ to Wₙ between sub-frame periods F_{1b} to F_{nb} of frame periods F₁ to Fₙ.

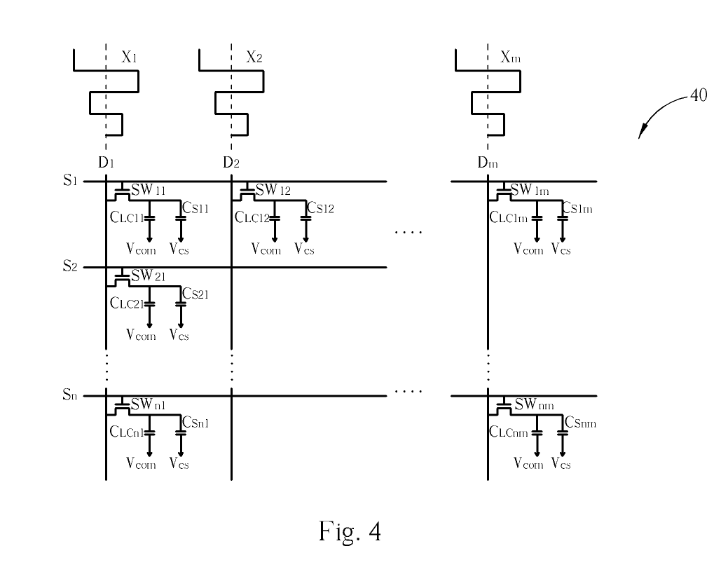

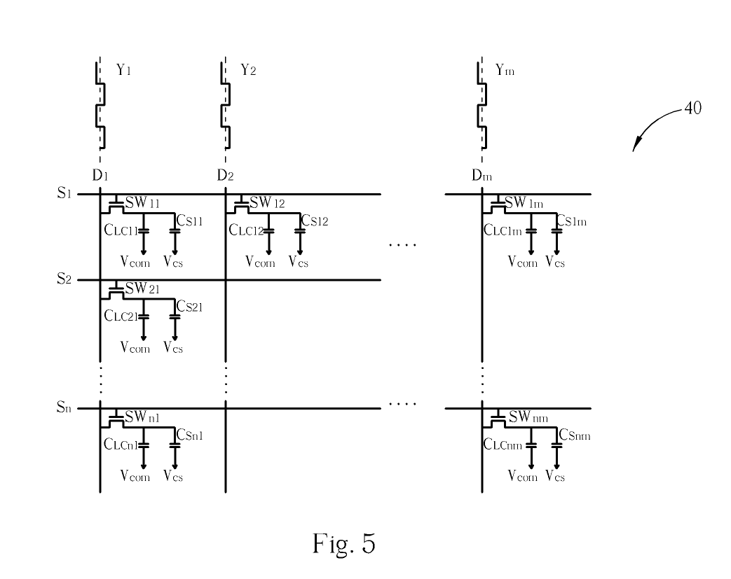

Please refer to FIG. 4 and FIG. 5. FIG. 4 shows the liquid crystal panel 40 of the liquid crystal display device 30 displaying normal images; whereas FIG. 5 shows the liquid crystal panel 40 of the liquid crystal display device 30 displaying white images. The liquid crystal display panel 40 comprises a plurality of parallel data lines D₁ to Dₘ and a plurality of parallel scanning lines S₁ to Sₙ. The data lines D₁ to Dₘ and scanning lines S₁ to Sₙ interconnect with each other to form a pixel matrix. There are thin film transistors acting as switches SW₁ to SWₙ, liquid crystal capacitors C_{LC11} to C_{LCnm} and storage capacitor Cₛ₁ to Cₛₙₘ electronic components and a power source C_{com} to V_{cs} in a pixel matrix for each pixel. Data lines D₁ to Dₘ and scanning lines S₁ to Sₙ are coupled to the source driver 32 and the gate driver 31 respectively.

In the sub-frame periods F₁ₐ to Fₙₐ of the frame periods F₁ to Fₙ, the liquid crystal display device 30 receives signals corresponding to the images P₁ to Pₙ. By the gate driver 31 opening the TFT switches of writing data into pixels, and the source driver 32 converting the received image information to corresponding data line voltages X₁ to Xₘ, the data line voltage X₁ to Xₘ are able to be pushed to the opened pixel through data line D₁ to Dₘ. As shown in FIG. 4, the images P₁ to Pₙ are therefore displayed in the sub-frame periods F₁ₐ to Fₙₐ of the frame periods F₁ to Fₙ.

In the sub-frame periods F_{1b} to F_{nb} of the frame periods F₁ to Fₙ, the liquid crystal display device 30 firstly opens the TFT switches of each pixel through the gate driver 31, then pushes the data line voltages Y₁ to Yₘ, which is corresponding to information of white images, to the opened pixel through data lines D₁ to Dₘ. As shown in FIG. 5, the white images W₁ to Wₙ are therefore displayed in the sub-frame periods F_{1b} to F_{nb} of the frame periods F₁ to Fₙ.

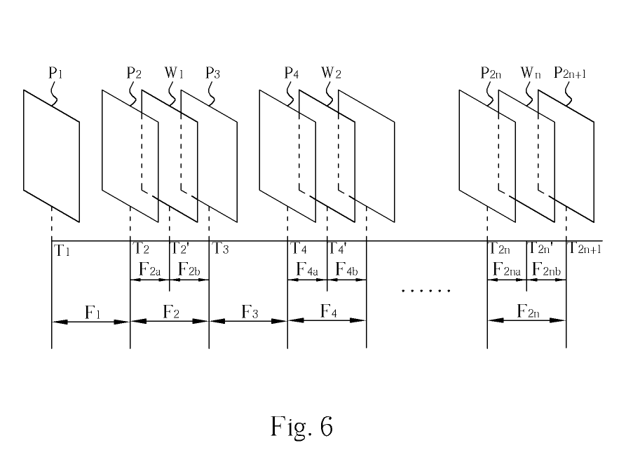

In the first embodiment of the present invention, a white image is inserted in between a normal image display of a frame period and a normal image display of the next frame period. However, the present invention is also able to insert a white image between a predetermined number of frame periods. Please refer to FIG. 6, which explains a second embodiment of the present invention. The second embodiment of the present invention is to minimize the image delay phenomenon by inserting white images. In FIG. 6, images P₁ to Pₙ represent the images displayed by a liquid crystal display device on a liquid crystal display panel at time T₁ to T₂ₙ₊₁; images W₁ to Wₙ are white images; and time intervals between each of the two sequential times T₁ to T₂ₙ₊₁ are defined as frame periods F₁ to F₂ₙ. In order to minimize the image delay phenomenon, the solution provided by the second embodiment is to insert a white image between a normal display image of a frame period and a normal display image of the next frame period. The first step is to divide each of the frame periods F₁ to F₂ₙ₊₁ into two sub-frame periods F₂ₐ to F_{2b}, F₄ₐ to F₄ₐ, . . . and F₂ₙₐ to F_{2nb}. The sub-frame periods F₂ₐ, F₄ₐ, . . . , and F₂ₙₐ start at times T₂, T₄, . . . , and T₂ₙ, whereas the sub-frame periods F_{2b} to F_{2nb} start at times T₂′, T₄′, . . . , and T₂ₙ′ respectively. Then, the liquid crystal display panel displays normal display images P₁ to Pₙ between sub-frame periods F₁ₐ to Fₙₐ of frame periods F₁ to Fₙ, and displays white images W₁ to Wₙ between sub-frame periods F_{1b} to F_{nb} of frame periods F₁ to Fₙ. Thereafter the liquid crystal display panel displays normal display images P₁, P₃, . . . , P₂ₙ₊₁ between odd frame periods F₁, F₃, . . . respectively, and displays normal display images P₂, P₄, . . . , P₂ₙ between even frame periods F₂ₐ, F₄ₐ, . . . , F₂ₙₐ respectively, while displaying white images W₁ to Wₙ between the sub-frame periods F_{2b}, F_{4b}, . . . , F_{2nb} of the even frame periods. The inserted white images W₁ to Wₙ not only minimize the image delay phenomenon but also retain the quality of vision performance of the luminance of the liquid crystal display panel.

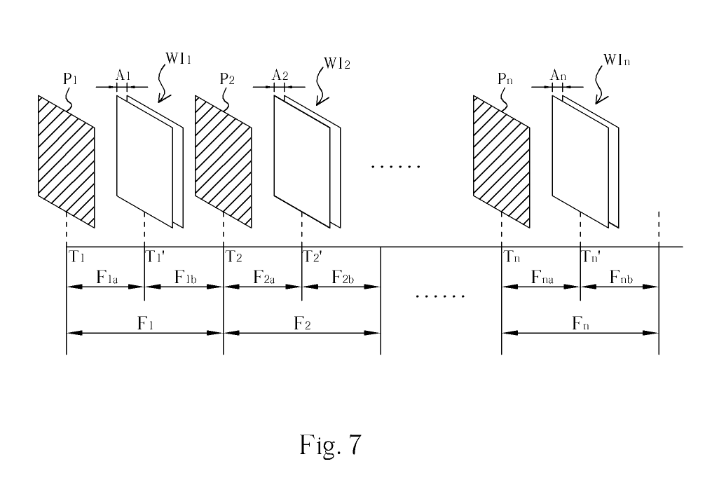

In the first and the second embodiments of the present invention, a white image is inserted in between a normal display image of a frame period and a normal display image of the next frame period, or in a predetermined number of frame periods. However, the present invention can also insert a plurality of white images instead. Please refer to FIG. 7, which explains a third embodiment of the present invention which is to solve the image delay phenomenon on liquid crystal display devices with a white image insertion technique. In FIG. 7, images P₁ to Pₙ represent the images displayed by a liquid crystal display device at time T₁ to Tₙ; time intervals between each of the two sequential times T₁ to Tₙ are defined as frame periods F₁ to Fₙ; images WI₁ to WIₙ are images each containing two white pictures; time intervals between two sequential white images are represented by A₁ to Aₙ and A₁ to Aₙ and can have equal values. Therefore, the inserted white images WI₁ to WIₙ minimize the image delay phenomenon without reducing the quality of vision performance of the luminance of the liquid crystal display panel.

In a third embodiment of the present invention, images P₁ to Pₙ can be sequential images of a moving image. The time intervals between each of the two sequential images P₁ to Pₙ can be equal to or larger than the time intervals between each of the two sequential white images W₁ to Wₙ, for example: F₁≧(F_{1b}+F₂ₐ). The white images WI₁ to WIₙ can comprise two or more white pictures, and the time interval between two sequential white pictures is smaller than the time interval between two sequential white images. For example, A₁<(F_{1b}+F₂ₐ).

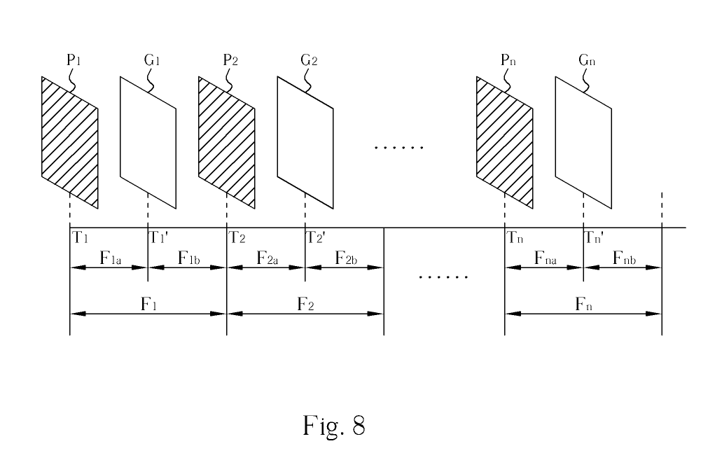

Please refer to FIG. 8, which explains a fourth embodiment of the present invention, which is to solve the image delay phenomenon on liquid crystal display devices with a white/gray insertion technique. In FIG. 8, images P₁ to Pₙ represent the images displayed by a liquid crystal display device at time T₁ to Tₙ; images G₁ to Gₙ are gray images; time intervals between each of the two sequential times T₁ to Tₙ are defined as frame periods F₁ to Fₙ. The fourth embodiment of the present invention is different from the first embodiment as the fourth embodiment inserts a gray image in between a normal image display of a frame period and a normal image display of the next frame period. The first step is to divide each of the frame periods F₁ to Fₙ into two sub-frame periods F₁ₐ to Fₙₐ and F_{1b} to F_{nb}, where the sub-frame periods F₁ₐ to Fₙₐ start at times T₁ to Tₙ and the sub-frame periods F_{1b} to F_{nb} start at times T₁′ to Tₙ′ respectively. Then the liquid crystal display panel displays normal display images P₁ to Pₙ between sub-frame periods F₁ₐ to Fₙₐ of frame periods F₁ to Fₙ, and displays gray images G₁ to Gₙ between sub-frame periods F_{1b} to F_{nb} of frame periods F₁ to Fₙ. Therefore, the inserted gray images G₁ to Gₙ minimize the image delay phenomenon without reducing the quality of vision performance of the luminance of the liquid crystal display panel.

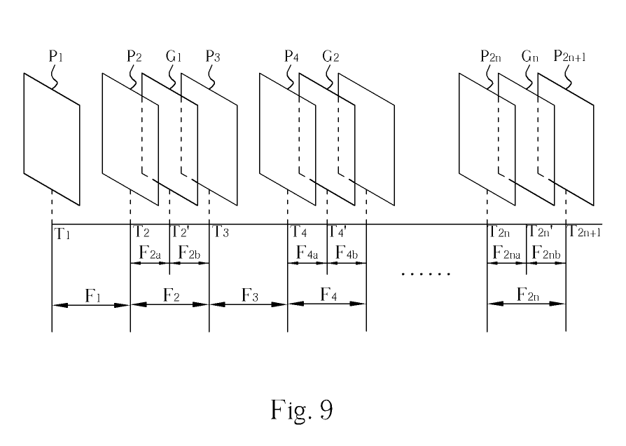

Please refer to FIG. 9, which explains a fifth embodiment of the present invention, which is to solve the image delay phenomenon on liquid crystal display devices with a white/gray insertion technique. The fifth embodiment of the present invention is different from the second embodiment as the fifth embodiment inserts a gray image in between a normal image display of a frame period and a normal image display of the next frame period. In FIG. 9, images P₁ to Pₙ represent the images displayed by a liquid crystal display device on a liquid crystal display panel at time T₁ to T₂ₙ₊₁; images G₁ to Gₙ are gray images; and time intervals between each of the two sequential times T₁ to T₂ₙ₊₁ are defined as frame periods F₁ to F₂ₙ. The first step is to divide each of the frame periods F₁ to F₂ₙ₊₁ into two sub-frame periods F₂ₐ to F_{2b}, F₄ₐ to F₄ₐ, . . . and F₂ₙₐ to F_{2nb}. The sub-frame periods F₂ₐ, F₄ₐ, . . . and F₂ₙₐ start at times T₂, T₄, . . . , and T₂ₙ, whereas the sub-frame periods F_{2b} to F_{2nb} start at times T₂′, T₄′, . . . , and T₂ₙ′ respectively. Then the liquid crystal display panel displays normal display images P₁ to Pₙ between sub-frame periods F₁ₐ to Fₙₐ of frame periods F₁ to Fₙ, and displays gray images G₁ to Gₙ between sub-frame periods F_{1b} to F_{nb} of frame periods F₁ to Fₙ. Thereafter the liquid crystal display panel displays normal display images P₁, P₃, . . . , P₂ₙ₊₁ between odd frame periods F₁, F₃, . . . respectively, and displays normal display images P₂, P₄, . . . , P₂ₙ between even frame periods F₂ₐ, F₄ₐ, . . . , F₂ₙₐ respectively, while displaying gray images G₁ to Gₙ between the sub-frame periods F_{2b}, F_{4b}, . . . , F_{2nb} of the even frame periods. Therefore, the inserted gray images G₁ to Gₙ minimize the image delay phenomenon without reducing the quality of vision performance of the luminance of the liquid crystal display panel.

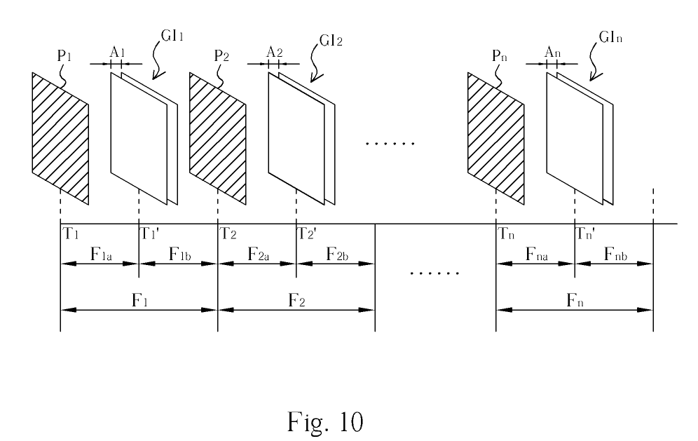

Please refer to FIG. 10, which explains a sixth embodiment of the present invention, which is to solve the image delay phenomenon on liquid crystal display devices with a white/gray insertion technique. The sixth embodiment of the present invention is different from the third embodiment as the sixth embodiment inserts a gray image in between a normal image display of a frame period and a normal image display of the next frame period. In FIG. 10, images P₁ to Pₙ represent the images displayed by a liquid crystal display device at time T₁ to Tₙ; time intervals between each of two sequential times T₁ to Tₙ are defined as frame periods F₁ to Fₙ; images GI₁ to GIₙ are images each containing two gray pictures; and time intervals between two sequential gray images are represented by A₁ to Aₙ and A₁ to Aₙ and can have equal values. Therefore, the inserted white images GI₁ to GIₙ minimize the image delay phenomenon without reducing the quality of vision performance of the luminance of the liquid crystal display panel.

In addition, in the first to the sixth embodiments of the present invention, the two sub-frame periods of the same frame period can have equal lengths or different lengths.

The prior art minimizes the image delay phenomenon by inserting black images and reducing the luminance of liquid crystal display devices and hence affecting the display quality. In comparison to the prior art, the present invention minimizes the image delay phenomenon by inserting white images or gray images. This significantly improves the quality of displaying moving images on liquid crystal display devices without reducing the quality of vision performance of the luminance of the liquid crystal display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying moving images on a liquid crystal display panel comprising:
the liquid crystal display panel displaying a first image;
the liquid crystal display panel displaying a white image or a gray image after displaying the first image;
the liquid crystal display panel displaying a second image subsequent to the first image after displaying the white image or the gray image.

2. The method of claim 1 wherein the liquid crystal display panel displaying the first image is the liquid crystal display panel displaying the first image at a first time frame of a frame period; and the liquid crystal display panel displaying the white image or the gray image is the liquid crystal display panel displaying the white image or the gray image at a second time frame of the frame period.

3. The method of claim 2 wherein a length of the first time frame of the frame period is equal to a length of the second time frame of the frame period.

4. The method of claim 1 wherein the liquid crystal display panel displaying the white image or the gray image is the liquid crystal display panel displaying one or more white frames or displaying one or more gray frames.

5. The method of claim 1 wherein the liquid crystal display panel displaying the first image is the liquid crystal display panel displaying one or more frames.

6. The method of claim 1 wherein the liquid crystal display panel displaying the second image is the liquid crystal display panel displaying one or more frames.

7. A method of displaying moving images comprising:
providing a moving image formed by a plurality of sequential frames, any two sequential frames of the plurality of sequential frames being separated by a first fixed time interval; and
providing a plurality of white images or gray images alternating with the plurality of sequential frames, any two sequential white or gray images of the plurality of white images or gray images being separated by a second fixed time interval.

8. The method of claim 7 wherein the first fixed time interval equals to the second fixed time interval.

9. The method of claim 7 wherein the first fixed time interval is larger than the second fixed time interval.

10. The method of claim 7 wherein each of the white images is composed of a white frame.

11. The method of claim 7 wherein each of the white images is composed of a plurality of white frames.

12. The method of claim 11 wherein any two white frames of the plurality of white frames are separated by a third fixed time interval.

13. The method of claim 12 wherein the second fixed time interval is larger than the third fixed time interval.

14. The method of claim 7 wherein each of the gray images is composed of a gray frame.

15. The method of claim 7 wherein each of the gray images is composed of a plurality of gray frames.

16. The method of claim 15 wherein any two gray frames of the plurality of gray frames are separated by a third fixed time interval.

17. The method of claim 16 wherein the second fixed time interval is larger than the third fixed time interval.
